(19) United States
(12) Patent Application Publication
(10) Pub. No.: US 2012/0246831 A1
(43) Pub. Date: Oct. 4, 2012

(54) HOSPITAL BED

(75) Inventor: Francois Paillusseau, Levallois-Perret (FR)

(73) Assignee: FLOTTEOR, Levallois-Perret (FR)

(21) Appl. No.: 13/500,144

(22) PCT Filed: Oct. 6, 2010
(86) PCT No.: PCT/FR2010/052103

§ 371 Date: Jun. 19, 2012

(30) Foreign Application Priority Data
Oct. 6, 2009 (FR) 0956966

(51) Int. Cl. A61G 7/002

(52) U.S. Cl. 5/624; 5/600; 5/621

(57) ABSTRACT

Hospital bed having a fixed structure and a movable structure connected to the fixed structure in such a way as to allow the movable structure to pivot in relation to the fixed structure, the movable structure being supported by the fixed structure, and the movable structure comprising an elongated patient lying region. The movable structure further comprises panels which can be moved selectively in relation to one another between a closed configuration wherein the elongated patient lying region is surrounded by the panels and an opened-out configuration wherein a part of said panels are separated from one another in such a way as to allow access to the elongated patient lying region.

### BACKGROUND

This invention relates to, in general, the field of hospital beds that make possible the pivoting of the lying region.

More particularly, the invention relates to a hospital bed comprising a fixed structure and a movable structure connected to said fixed structure in such a way as to allow the movable structure to pivot in relation to a said fixed structure, said movable structure being supported by said fixed structure, this movable structure comprising an elongated patient lying region adapted to receive patient in a stretched out position.

### SUMMARY OF THE INVENTION

This invention has for purpose to propose a hospital bed making it possible to facilitate access to the patient lying region. For the comprehension of the invention, the term patient designates a human being having a trunk, a head, two arms and two legs.

To this end, the bed of the invention, moreover compliant with the generic definition given to it by the preamble defined previously, is substantially characterised in that said movable structure further comprises at least three panels which can be moved selectively in relation to one another between a closed configuration wherein said lying region of the movable structure is surrounded by said at least three panels and at least one opened-out configuration wherein at least two of said at least three panels are separated from one another in such a way as to allow access to said lying region.

In order to access the lying region one or those panels of the at least three panels can be chosen which is/are the best positioned and which is/are above this lying region as such limiting the risk of disturbances of the patient. Having at least three panels distributed around the lying region makes it possible to increase the possibilities of access to the lying region since in each position at least one panel is supporting, and at least one other panel is non-supporting, and can therefore be open; each non-supporting panel allowing for access without however compromising the support of the patient in the lying region, carried out by the supporting panel or panels.

Also, the invention makes it possible through the use of said at least three panels:
to favour heat exchanges around the body of the patient by opening certain panels more or less;
to decrease a feeling of enclosure of the patient in the lying region.

Preferentially the panels are adapted to adopt several opened-out configurations, with one at least of these opened-out configurations being adapted so that at least one of the panels supports the elongated lying region and so that the separation between at least two of said panels is sufficient to allow for the passage of the patient between these separated panels in order to stretch out the patient in the lying region or alternatively to remove the patient from the lying region.

This embodiment makes it possible to increase the possibilities of introducing a patient in the lying region, either by choosing a first region of passage of the patient between two of the panels or by choosing a second region of passage of the patient between two other panels. As such, according to the passage between the panels which is chosen (i.e. according to the opened-out configuration chosen) the patient can be introduced in the lying region by stretching out the patient on his back, or on a front face with this choice being according to the pathology of the patient or of the care to be initially given.

Preferentially each panel is adapted to pivot by an angle of at least 220° and preferentially of 270° between its closed and opened-out configurations.

This rotation of at least 220° and preferentially of 270° allows access for care attendants at the edge of said movable part and therefore in the vicinity of the patient.

Preferentially a given panel is in opened-out configuration with maximum opening when it is pivoted 270° starting from its closed configuration.

For the implementation of this characteristic, it is arranged that each panel comprises at least two faces forming between them an angle of 135° plus or minus 10°.

According to a particular embodiment of the invention, said movable structure comprises means of leg support of the patient, these means of leg support being arranged in order to maintain a separation between the legs of a patient lying down in the lying region and being adapted to prevent the weight of one of said legs of this patient from being transferred to the other of these legs in particular in lateral decubitus or close position.

Through this characteristic, the weight of a leg is never transferred onto the other of these legs which reduces the risk of the appearance of pressure sores in particular on the interior of the legs. The transfer of weight from one leg to the other exists in particular when the patient is placed in lateral position, this results in poor blood circulation of the leg placed in lower portion multiplying by as much the risk of pressure sores. The suppression of such a transfer of weight is therefore particularly advantageous.

According to a particular embodiment of the invention, said movable structure comprises means for supporting the trunk of a patient, these means for supporting the trunk being arranged to independently support the trunk and the arms of the patient lying down in the lying region, and being adapted to prevent the weight of the trunk of this patient from being transferred onto one of the arms of this patient which would be placed parallel to the trunk.

By this characteristic, in the lateral positions, the weight of the trunk is never transferred onto one of the arms which reduces the risk of the appearance of pressures sores on the arm located in the lower portion, under the trunk.

Thanks to said means of leg support of the patient and to said means for supporting the trunk of the patient the legs the trunk and the arms are supported independently from one another, which allows for an optimal distribution of the support pressure of the patient in all of the pivoting positions of the movable structure, and in particular the prolonged maintaining of the patient in the lateral positions.

According to a particular embodiment of the invention, the movable structure is adapted to pivot in relation to the fixed structure according to a pivoting axis extending parallel to a main axis of elongation of the elongated lying region.

Through this embodiment it is arranged that the pivoting allows for a turning over of the patient lying down in the movable structure in relation to the fixed structure according to a pivoting axis extending parallel to an axis of symmetry of the patient passing between the legs of the patient lying down and passing through his head. Such a turning over is useful as it allows for the turning over of the patient in all of the positions of the rotation around said axis.

Preferentially the pivoting axis is horizontal.

Preferentially the pivoting axis extends parallel to the main axis of elongation of the elongated lying region is a horizontal axis.

According to a particular embodiment of the invention, said movable structure comprises:
at least one front support surface adapted to receive as support at least one portion of the front face of said patient lying down in said lying region; and
at least one rear support surface adapted to receive as support at least one portion of the rear face of said patient lying down in said lying region,

these said at least one front and rear surfaces of support being placed opposite one another at least when said panels are in closed configuration.

This embodiment makes it possible to brace the patient in the lying region by maintaining panels in closed configuration, which makes it possible to carry out the rotations without the patient leaving his stretched-out position opposite said pivoting axis, which is comfortable.

According to a particular embodiment of the invention, the bed comprises four panels which can be moved selectively in relation to one another between said closed configuration and said at least one opened-out configuration and:
in said closed configuration, said lying region of the movable structure is surrounded by said four panels,
in said at least one opened-out configuration at least two of the four panels are separated from one another in such a way as to allow access to said lying region in order to stretch out said patient therein.

The use of 4 panels multiplies the possibilities of access to the lying region without compromising the supports of the patient who is stretched out therein.

According to a particular embodiment of the invention combined with the preceding embodiment, two of said four panels form a first pair of panels and two other of said four panels form a second pair of panels said four panels being adapted to adopt:
a first opened-out configuration wherein the panels of said first pair of panels are separated from one another in such a way as to allow for an access to said lying region by passing between the panels of said first pair of panels; and
a second opened-out configuration wherein the panels of said second pair of panels are separated from one another in such a way as to allow for an access to said lying region by passing between the panels of said second pair of panels.

This embodiment makes it possible to have access to the lying region via the panels of the first pair or via the panels of the second pair, with the other pair of panels not used for access to the lying region being used as support for the lying region.

According to a particular embodiment of the invention combined with the preceding embodiment, the panels are arranged in such a way that when they are in closed configuration:
the panels of said first pair of panels are arranged opposite a front face of a patient lying down in said lying region; and
the panels of said second pair of panels are arranged opposite a rear face of said patient lying down.

In this way when the panels are in the first opened-out configuration access is possible to the front face of the patient lying down, and when the panels are in the second opened-out configuration access is then possible to the rear face of the patient lying down. These differentiated accesses are useful for providing for example care for the front or rear face of the patient, with the care for the front face being preferentially carried out while the patient supported by the second pair of panels and the care for the rear face being preferentially carried out while the patient supported by the first pair of panels.

According to a particular embodiment of the invention said movable structure comprises a chassis and said liaison of the movable structure and of said fixed structure allows for said pivoting of the movable structure in relation to said fixed structure by mechanical connections between said fixed structure and said chassis.

According to a preferred embodiment it is arranged that said lying region of the patient comprises a first portion of lying region adapted to accept a first leg of a patient lying down in the lying region and a second portion of lying region adapted to accept a second leg of the patient lying down in said lying region, said means of leg support of the patient, being arranged between first and second portions of the lying region of legs of the patient lying down, these means of leg support being assembled rigidly to said chassis of the movable structure in such a way as to prevent the weight of one leg of the patient from being able to be transferred onto the other of these legs and said panels being mounted movable in relation to the chassis and one at least of said sections of mattress being assembled to at least one of said panels and being arranged in such a way that when said panels are in closed configuration, said first portion of lying region adapted to accept the first leg of the patient lying down in the lying region is located between a portion at least of said means of leg support and said at least one of said sections of mattress in such a way as to allow a lateral bracing on either side of said first portion of lying region.

As a complement to the preceding embodiment its can also be arranged that at least one other of said sections of mattress assembled to at least one other of said panels are arranged in such a way that when said panels are in closed configuration, said second portion of lying region adapted to accept the second leg of the patient lying down in the lying region is then located between a portion at least of said means of leg support and at least this other at least one section of mattress in such a way as to allow a lateral bracing on either side of said second portion of lying region.

Thanks to the two preceding embodiments each leg can have an internal lateral face braced against a portion at least of said means of leg support fixed to the chassis and an external lateral face of the leg braced against at least one section of mattress corresponding to this leg and supported by a movable panel in relation to the chassis. Thanks to this embodiment the internal leg bracing is always present (even when an external bracing is suppressed by opening a panel). As such the risk of a transfer of weight of one leg onto the other is permanently prevented while still having a selective external bracing of the legs by mattresses assembled to the movable panels. As such the external bracing will be carried out on a first leg placed under the second leg and the external bracing will be preferentially suppressed on the external lateral face of this second leg as it is then in the upper portion. Thanks to this embodiment to suppress an external bracing it is sufficient to displace the panel supporting the portion of mattress provided for the external bracing so that it passes to opened-out position. On the contrary, in order to obtain an external bracing, it is sufficient to close this panel supporting the portion of mattress provided for the external bracing.

According to a particular embodiment of the invention the chassis comprises an elongated rectangular peripheral frame, formed of two rails representing its large sides, parallel to said main axis of elongation of the elongated lying region, and of two crosspieces representing its small sides, said rails supporting said panels. Said frame is rotably mounted in relation to said fixed structure by first and second pivots respectively located on either side of said frame and on the respective longitudinal ends of said frame and in particular on said crosspieces.

With such a frame the movable structure is rigidified and the links between the movable structure and the fixed structure are multiple as such increasing the resistance of the bed of the invention while still reducing the risk of the appearance of overhang and parasite movements able to render the lying region uncomfortable.

Preferentially the chassis comprises respective first and second discs assembled to the longitudinal ends of the frame, and in particular to said crosspieces in such a way as to be parallel between them and to have confounded axes of revolution, said first and second pivots being respectively formed on the respective first and second discs.

Preferentially the bed of the invention comprises means of selective indexing in rotation of the movable structure in relation to the fixed structure.

According to a particular embodiment of the invention each of said panels is rotably mounted in relation to the frame and in particular to the rails of the frame. This embodiment allows for a rotation of the fixed structure in relation to the movable structure which is independent of the rotations of the panels opposite the frame.

Preferentially each of the panels is rotably mounted according to its own axis of panel rotation. In this way the movement of separation or coming closer of a panel in relation to the lying region is carried out according to a direction of panel displacement transversal to the main axis of elongation of the lying region. This characteristic makes it possible to facilitate the separation between two neighbouring panels and therefore to allow for accelerated access to the lying region in relation to what it would be if the panels were mounted in rotation according to an axis perpendicular to the main axis of elongation of the lying region.

Preferentially the means of leg support extend according to a direction parallel to the main axis of elongation of the elongated lying region.

Preferentially the frame comprises at its periphery two rails extending according to the length of the frame and two crosspieces extending transversally in relation to the length of the frame, the means of leg support being connected rigidly to one of said crosspieces of the frame and being preferentially at a distance from the rails of the frame. This embodiment makes it possible to stabilise the means of leg support in relation to the entire lying region which is defined in a frame.

Preferentially these means of leg support comprise a first portion forming a cushion which is opposite one of said rails and a second portion forming a cushion placed opposite the other of said rails.

Each cushion therefore makes it possible to have a distribution of the forces between the legs and the means of leg support.

Preferentially the means for supporting the trunk of a patient, comprises supports separated from one another in order to allow for the passage of the trunk of said user stretched out between these supports, these supports being of elongated shape, integral with said chassis, here with said frame via an assembly of adjustable screws, perpendicular to the main plane of said frame, and which must each be adjusted so as to allow for support of cushions of sufficient thickness on the arm side and on the trunk side.

Preferentially each elongated support supports, on the trunk side, the sections of cushions integral with the panels placed on its side, and on the arm side, a second proper portion of cushion placed opposite the rail of said nearest frame.

Each first portion of cushion allows for a distribution of weight of the trunk on the elongated support when the patient is lying in lateral position as such reducing the risk of the appearance of pressure sores on the trunk between the trunk and the arms, and the risk of crushing of the arm which is located at the bottom.

Likewise a second proper portion of cushion of the elongated support is placed opposite the rail which is the nearest so as to allow, always in lateral position, the support of the arm of the patient placed between this support and this rail.

Preferentially each of said respective elongated supports is arranged to oppose the contact between one of said respective arms of the patient and a side of the trunk of this patient lying down in the lying region, and to support the arms and the trunk independently of each other in particular in the lateral or close positions.

Preferentially each of said elongated supports is connected rigidly to that of said rails of the frame which is nearest to it. This embodiment makes it possible to suppress any relative movement between the elongated supports and the lying region, as they are connected to the frame.

According to a particular embodiment of the invention, the bed comprises means for locking panels that are selectively movable between:
a locking configuration prohibiting the passage of the panels from their closed configuration to their opened-out configuration; and
an unlocking configuration that authorises the passage of the panels from their closed configuration to their opened-out configuration.

Preferentially each of said panels is movable between an opened-out position wherein it is most separated from the elongated lying region of the patient and a closed position wherein it is brought closer to the elongated lying region, relatively to the separation of the panel in opened-out position, the panels being in opened-out configuration when at least one of said panels is placed in opened-out position and the panels being in closed configuration when all of the panels are in closed position.

Of course each panel can adopt several opened-out positions of which one maximum opened-out position and intermediary positions between the closed position and the opened-out position.

Preferentially the bed according to any one of the embodiments of the invention comprises means of actuating panels adapted to displace the panels between their opened-out configuration and their closed configuration.

Preferentially the means of actuating are adapted to displace each panel independently from the displacement of the other panels. Such means of actuating comprise cylinders, each cylinder being connected on the one hand to a corresponding panel and on the other hand to the chassis, here to the frame, and being adapted to displace the panel to which it is connected between its opened-out (here maximum opening) and closed positions.

If the means of actuating do not allow for the full movement of 270° until the position wherein the panel is fully retracted under the movable part, the link between the panel and the means of actuating that correspond to it is then preferentially able to be disconnected, in such a way as to make it possible to manually reach another position of maximum opening referred to as disconnected, this position being further separated, and is reached when said panel is fully retracted under its axis of rotation.

According to a particular embodiment of the invention the bed comprises several sections of mattress and said elongated lying region is surrounded by said sections of mattress when said panels are in closed configuration, each of said sections of mattress being assembled to one of said panels or to one of the supports for the trunk or legs.

This embodiment makes it possible to displace each of the sections of mattress at the same time as the panel to which it is attached is displaced, while still remaining fixed in relation to the frame the sections of mattress which are attached to the leg or trunk supports. As such each section of mattress is automatically positioned around the lying region at the same time as the panel is displaced as such making it possible to comfortably surround, brace, protect the patient by contact with sections of mattress and as such making it possible in complete safety a rotation of the movable part.

Preferentially the surfaces of the sections of mattress intended to be opposite the elongated lying region when the panels are in closed configuration form a continuous surface without empty space between the sections of mattress.

The absence of empty space between the sections of mattress makes it possible to reduce the risks of pinching the skin of the patient lying down in the lying region and to maximise the support surface of the patient.

Preferentially each section of mattress is assembled on one of the panels which is proper to it in such a way that said elongated lying region is surrounded by several sections of mattress each movable with one of the panels.

Preferentially the bed comprises at least four sections of mattress attached to the panels and each comprising a hollow region adapted to accept a portion of the body of the patient.

Preferentially:
a first of the four sections of mattress is in the form of a hollow in order to accept and hug the shape of a portion at least of a rear right quarter of the body of the patient lying down,
a second of the four sections of mattress is in the form of a hollow in order to accept and hug the shape of a portion at least of a rear left quarter of the body of the patient lying down,
a third of the four sections of mattress is in the form of a hollow in order to accept and hug the shape of a portion at least of a front right quarter of the body of the patient lying down,
a fourth of the four sections of mattress is in the form of a hollow in order to accept and hug the shape of a portion at least of a front left quarter of the body of the patient lying down. This embodiment makes it possible to have sections of mattress shaped to hug the forms of the patient and surround him at least partially while still allowing the possibility for access to a region of the body of the patient by opening at least one of the panels supporting one of these sections of mattress.

Preferentially these four sections of mattress are shaped to define the elongated lying region and so that, when the panels are in closed configuration, these sections of mattress compose a hollow shape adapted for:
accepting the legs of the patient lying down by maintaining the relative position between them;
accepting the trunk and the arms of the patient lying down by maintaining the position of said arms and of said trunk relatively to each other.

Said supports of legs and of arms are also provided with sections of mattress which are attached to them, in such a way that the sections of mattress of the leg supports support the interior of the legs and those of the arm and trunk supports support the arm on one side, and the trunk on the other side. As such, in lateral position, even if the non-supporting panels (here a non-supporting panel is a panel located above a supporting panel) are open, the leg and the arm of the top continue to be supported comfortably. The leg and the arm at the bottom are then supported by the sections of mattress integral with the supporting panels (here a supporting panel is a panel located under a supporting panel, the panels being supporting or non-supporting according to the pivoting position of the movable part which is chosen). The trunk is supported by the sections of mattress integral with supporting panels but which press on the lower arm support.

According to a particular embodiment of the invention the sections of mattress are each replaced with a block made of a more firm material, for example of PU foam, shaped to be at a constant distance from the body, for example 3 cm, and by cushions of air or of fluid fixed on said block, and shaped to support the corresponding portion of the body by pressing on said block. The cushions of air or of fluid can be inflated or deflated in such a way as to obtain a perfect distribution of the support pressure over the entire body.

According to a particular embodiment the bed according to the invention comprises several blocks and said elongated lying region is surrounded by said blocks when said panels are in closed configuration, each one of said blocks being assembled to at least one of said panels and cushions being arranged between said blocks and said elongated lying region. The blocks are an element with rigidity that is higher than the rigidity of a section of mattress and are for this combined with cushions allowing for a support that is better distributed of the body on the block. Preferentially each cushion inserted between a block and the lying region has a thickness of at least 3 cm.

In order to produce a block or a mattress formed from several sections of mattress:
a step of measuring the morphology of the body of the patient is carried out, preferentially via three-dimensional scanning, then
computer-assisted design is used to create a virtual complementary shape of the scanned shape of the body of the patient and having external shapes able to be housed in the movable structure; then
a virtual shape is generated to be machined by possibly removing from the virtual complementary shape spaces in particular around the ears, neck, mouth of the patient and possible for the positioning of cushions and/or of medical equipment; then
an real shape equivalent to the virtual shape is generated to be machined, for example by moulding or milling; then
the equivalent real shape is cut to form sections of mattress or sections of blocks ready to be arranged on the panels or on the arm or leg supports, and ready to hug portions at least of the body of the patient.

As such the mattress formed of several sections of mattress or the blocks and the cushions are adapted to the shape of the body of the patient.

According to a particular embodiment of the invention the bed comprises means of motorisation of the pivoting of the movable structure in relation to said fixed structure. This embodiment makes it possible to control the displacement of the fixed structure in relation to the movable structure without necessarily having need of human intervention. As such the pivoting of the lying region is carried out without effort which allows the patient to access any position with or without the intervention of the care attendants.

Preferentially these means of motorisation comprise an electric motor connected on the one hand to the fixed structure and on the other hand to the movable structure to control the displacement thereof.

The invention also relates to a method for actuating a bed according to at least one of the embodiments of bed presented previously. This method of the invention comprising:
a step of displacing panels towards their closed configuration with a patient lying down in said elongated lying region; then
a step of pivoting of the movable structure in relation to said fixed structure in such a way as to place the movable structure in the desired position; then
a step of displacing non-supporting panels (a non-supporting panel is a panel placed above the lying region) in their said at least one opened-out configuration in such a way that said at least one non-supporting panel is separated at least partially from the elongated lying region and as such allows access to the patient located in the elongated lying region or a better circulation of the air.

Thanks to the bed according to the invention and to the method of the invention, the risk of the appearance of pressure sore(s) in a patient lying down in the lying region is reduced since its pivoting can be carried out easily, as often as necessary or as often as desired, and without risk of the patient falling due to the fact that the pivoting can be carried out while the panels are then in closed configuration. Also thanks to the method of the invention, access to the patient remains possible after the step of pivoting since the non-supporting panel or panels (here the panels located above the lying region) can be separated from the lying region, with the supporting panels being used to support the lying region. Moreover with the bed according to the invention a panel can be used in turn as a means for access to the elongated lying region or as a support for the lying region according to whether it is in non-supporting position or in supporting position.

Preferentially this method of controlling according to the invention is automated in such a way that said steps of displacing panels in their closed or opened-out configuration and of pivoting the movable structure are carried out automatically at least one time over a maximum period of two hours. Preferentially, said means of motorisation can also be controlled either by the patient thanks to means of control placed in the lying region, or by the care attendants thanks to means of control placed outside of the lying region.

### BRIEF DESCRIPTION OF THE DRAWINGS

Other characteristics and advantages of the invention result clearly from the following description of it, for the purposes of information and in no way restrictive, in reference to the annexed drawings, wherein:

FIG. 1 shows a hospital bed 1 according to the invention provided with a fixed structure 2 and a movable structure 3 mounted in rotation in relation to the fixed structure 2 and according to axes of pivoting 9 of the movable structure 3, it is observed in this figure that the movable structure 3 comprises four panels 6a, 6b, 6c, 6d which are in closed configuration;

FIG. 2 shows the hospital bed of the invention with its panels in one of the opened-out configurations: a first pair 13a of panels 6a, 6b are placed in opened-out positions and separated from one another in order to leave an access to a front face of the elongated patient lying region 4 and a second pair 13b of panels 6c, 6d are placed in closed positions in such a way that these panels 6c, 6d are close to each other, these panels 6c, 6d of the second pair of panels 13b are placed under the panels 6a, 6b of the first pair 13a in such a way that they are used, in this opened-out configuration, as support for the elongated lying region 4;

FIG. 3 shows a longitudinal cross-section view of the movable structure 3 of the bed 1 according to the invention, this section being according to a main axis of elongation 10 of the lying region 4 which is confounded with the pivoting axis 9 of the movable structure 3 in relation to the fixed structure 2;

FIG. 4 shows a cross-section view (according to a plane parallel to a front face of the patient lying down in the lying region) of the movable structure 3 wherein is seen the chassis 14 of the movable structure 3 which surrounds the elongated lying region 4 and wherein is seen the means of support 8 of the trunk 5a of the patient 5 and means of support 7 for the legs 5d of the patient 5, it can also be seen in this FIG. 4 the manner in which these means of support 7 and 8 are connected to the frame 16 of the chassis 14;

FIG. 5 shows a half-view of a transversal cross-section of the movable structure 3 (perpendicularly to the main axis of elongation 10 of the elongated lying region 4) on a portion of the lying region 4 that accepts the trunk of the patient 5a, in this FIG. 5 the means for supporting the trunk 8 can be seen making it possible to maintain the arms 5c separated from the trunk 5a and preventing a transfer of weight of the arm 5c onto the trunk 5a and vice versa, in this FIG. 5 the panel 6a of the first pair of panels 13a is in opened-out position as such allowing for access to the front face of the patient 5;

FIG. 6 shows a half-view of a transversal cross-section of the movable structure 3 (perpendicularly to the main axis of elongation 10 of the elongated lying region 4) on the portion of the lying region 4 that accepts the legs 5d of the patient 5, in this FIG. 5 the means of support for the legs 7 can be seen making it possible to maintain the legs 5d separated between them and preventing the weight of one leg from being able to be transferred onto the other leg and vice versa, in this FIG. 5 the panels are in the same opened-out configuration as that in FIG. 5 as such allowing for access to the front face of the patient 5, in these FIGS. 5 and 6 the movable structure 3 is positioned in such a way that the patient is stretched out on a rear support surface 12 making it possible to accept the rear of the body of the patient in support;

FIG. 7 shows a transversal cross-section view of the movable structure 3 (perpendicularly to the main axis of elongation of the elongated lying region 4) on the portion of the lying region 4 that accepts the legs 5d of the patient 5, in this FIG. 7 all of the portions of the bed 1 can be seen which are shown in FIG. 6 but here the patient is in lateral position and it is observed that the leg placed the highest rests solely on the means of leg support 7, in this FIG. 7 the panels are in another opened-out configuration allowing access to an entire right side of the patient on his front as well as rear faces, in this FIG. 7 the movable structure 3 is positioned in such a way that the patient is stretched out on the side and is supported by the panels 6a, 6d which are in closed position, the two other panel 6b, 6c being in opened-out position;

FIG. 8 is a view similar to the view of FIG. 4, but wherein are shown the various blocks in hatched lines which define a portion of the lying region, the cushions of air or of fluid which are inserted between said blocks and the body, as well as the means for supporting the trunk 8 and legs 7 which are also provided with blocks and cushions (this figure shows only the first 24a, and second section of mattress 24b);

FIG. 9 is a transversal cross-section view of the movable structure 3 (perpendicularly to the main axis of elongation 10 of the elongated lying region 4) on the portion of the lying region 4 that accepts the trunk 5a of the patient and his arms 5c, in this FIG. 9 the panels are in one of their opened-out configurations wherein the panels 6a, 6b of the first pair of panel 13a are in opened-out positions while the panels 6c, 6c of the second pair of panels 13b are in closed positions and support the body of the patient, this figure shows the means for supporting the trunk 7 that maintain the arms away from the trunk and it can furthermore be seen that the first, second, third and fourth blocks 24a, 24b, 24c, 24d are respectively assembled on one of said respective third, fourth, first and second panels 6c, 6d, 6a, 6b, and support the cushions of air or of fluid 28 etc. which in turn will come to support the body.

FIG. 10 shows an exterior view of a longitudinal end of the movable structure 3 wherein the four panels in closed positions can be seen, the panels being as such in closed configuration, the frame 14 can be perceived which surrounds the elongated lying region 4 and the respective axes of rotation 17a, 17b of the panels, each of the panels passing from an opened-out position to a proper closed position via rotation according to one of these axes 17a, 17b, the axis of rotation 17a is carried out parallel to a rail 18a of the frame 16 and the other axis of rotation 17b is carried out parallel to the other rail 18b of the frame 16, these rails being carried out at their ends by crosspieces 19a, 19b, (also visible in this FIG. 10); four telescopic cylinders can also be seen connecting respectively each of the respective panels 6a, 6b, 6c, 6d to the chassis 14 and being used for the actuating of the panels by variation in their length, each of the cylinders 23 as such displacing one of the four panels to which it is assembled; it can also be seen in this FIG. 10 (as well as in the FIGS. 1 to 3) means for locking 22 panels in their closed positions, each of these means making it possible to lock or unlock each panel independently of the other panels, the means for locking 22 comprise on each panel two rods proper to this panel and slidingly mounted on this panel, the chassis 14 of the movable structure 3 comprises 8 strikes each intended to be opposite one of said sliding bars when the panel supporting this bar is in closed position, each rod as such able to be positioned via sliding in a strike proper to the rod as such locking the corresponding panel in its closed position.

### DETAILED DESCRIPTION OF THE PREFERRED EMBODIMENT(S)

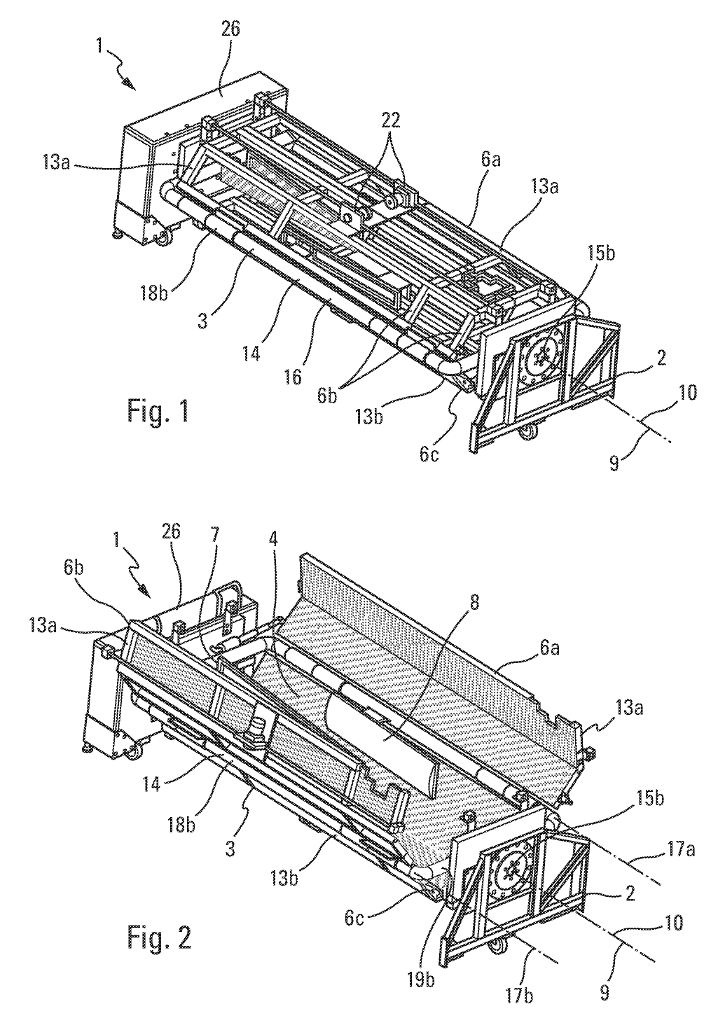

As can be observed in FIGS. 1 and 2 the hospital bed of the invention comprises a fixed structure 2 distributed into two separate units located on either side of the movable structure 3 wherein is formed the elongated lying region 4.

Each unit supports a pivot link connecting this unit to an end of the chassis of the movable structure 3, these pivot links allow for a rotation of the movable structure 2 and therefore of the lying region 4 according to a substantially horizontal axis 9 and confounded with a main axis of elongation 10 of the lying region 4.

The units forming the fixed structure 2 can possibly be connected together by rails, but this is not mandatory if the pivot links 15a and 15b are sufficiently resistant.

A motor 26 is used to control the pivoting of the movable structure 3 in relation to the fixed structure 2, this motor being connected to electrical means of control (not shown in the figures). These electrical means of control can include means of actuating by the patient which can be accessed from the interior of the lying region and other means of actuating which are assembled on the fixed structure 2 to be actuated by an exterior user. In both cases the electrical means of control are provided to control a pivoting of the movable structure between predefined pivoting positions comprising at least one position for the patient lying flat on his back, a position for the patient lying flat on his stomach, a left lateral position and a right lateral position. Ideally the means of control are automated so that the passage from one position to another can also be carried out without user intervention at intervals of time that are chosen in advance and are programmed.

The movable structure comprises a peripheral elongated frame 16 of the lying region 4 formed of two rails 18a, 18b and two crosspieces 19a, 19b. The movable structure comprises four panels 6a, 6b, 6c, 6d each rotably mounted on a corresponding rail of the frame in such a way that the panel rotation panel is parallel to the pivoting axis 9. A panel 6a is provided to be placed opposite a front right face of the lying region and another panel 6b is provided to be placed opposite a rear right face of the lying region, these two panels are mounted in rotation around the same axis 17a extending parallel to the right rail 18a of the frame 16. A panel 6c is provided to be placed opposite a front left face of the lying region and another panel 6d is provided to be placed opposite a rear left face of the lying region, these two panels are mounted in rotation around the same axis 17b extending parallel to the left rail 18b of the frame 16.

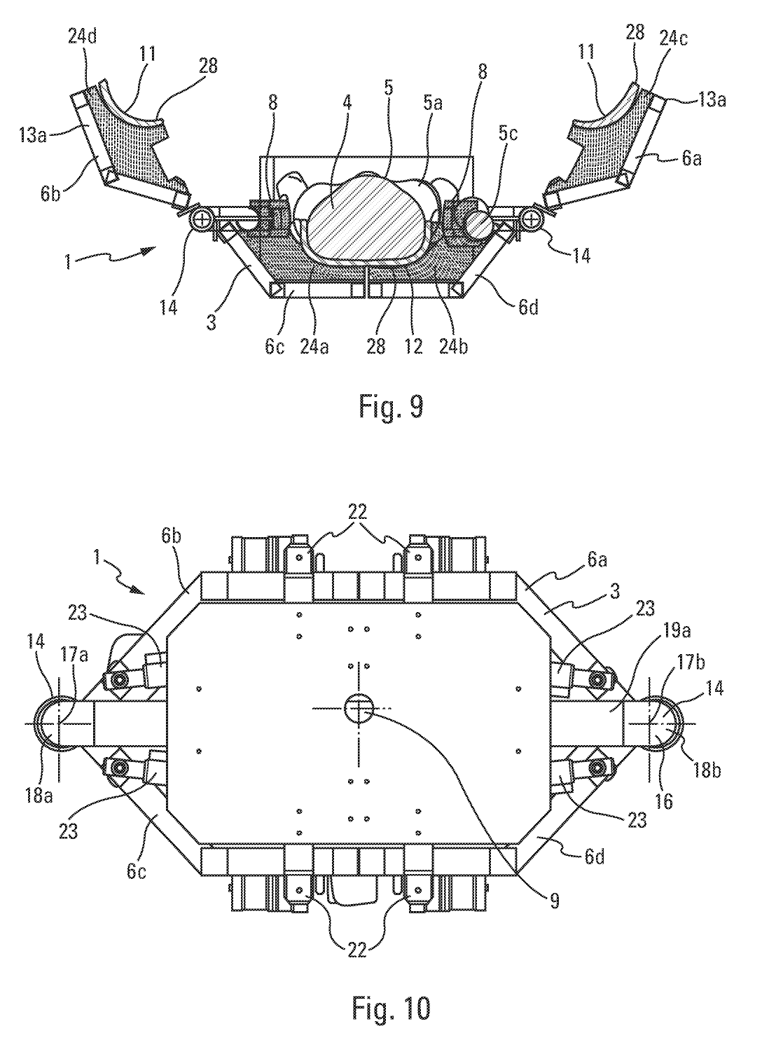

As indicated previously each panel supports a section of associated mattress, the lying region comprising therefore at least 4 sections of mattress. Each section of mattress comprises a hollow shape provided to be complementary on the portion of the body of the patient. As can be seen in FIG. 9 of the interfaces 28, here cushions 28 between sections of mattress and body of the patient can be used to best protect the patient against the risks of pressure sores. Such a cushion 28 can be inflated with air, or with a coolant connected to a cooler or heater for this liquid, as such making it possible to adjust the temperature around the body of the patient.

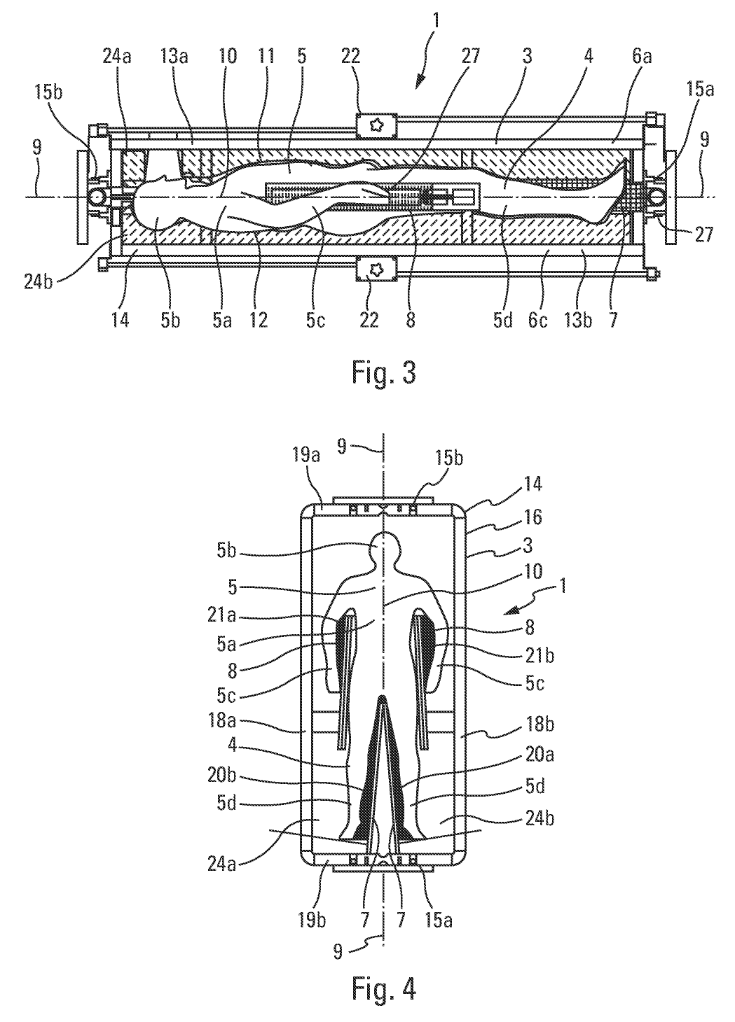

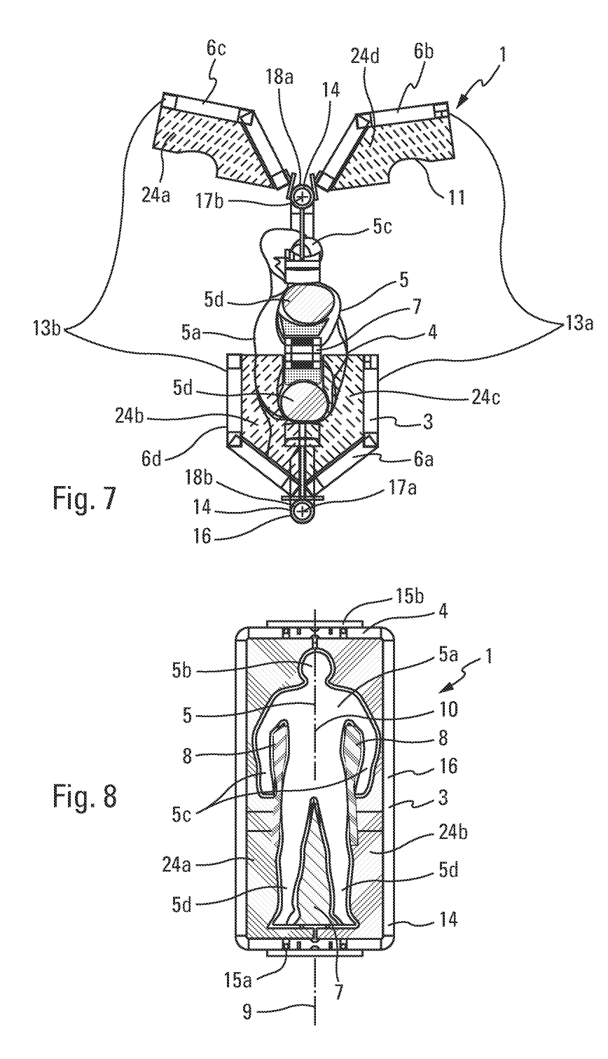

As can be seen in FIGS. 2 to 4 and 6 to 8 the movable structure comprises means of leg support 7 formed by rods fixed to the frame 16 and extending in an inter-leg space of the patient formed in the lying region. The means of leg support 7 can be adjusted in length and in width in such a way as to conform to the morphology of the patient. As can be seen in FIGS. 4 and 6 the means of leg support 7 carry cushions 20a, 20b, each respective cushion 20a and 20b being placed at the location of the contact with one of the respective legs of the patient.

Cushions can also be provided to maintain the head of the patient 5b, and the sections of mattress as well as the panels comprise cut-outs so that the patient can communicate, breath, see, and so that the face of the patient can be seen from the exterior of the movable structure 3 even when the panels are in closed configuration.

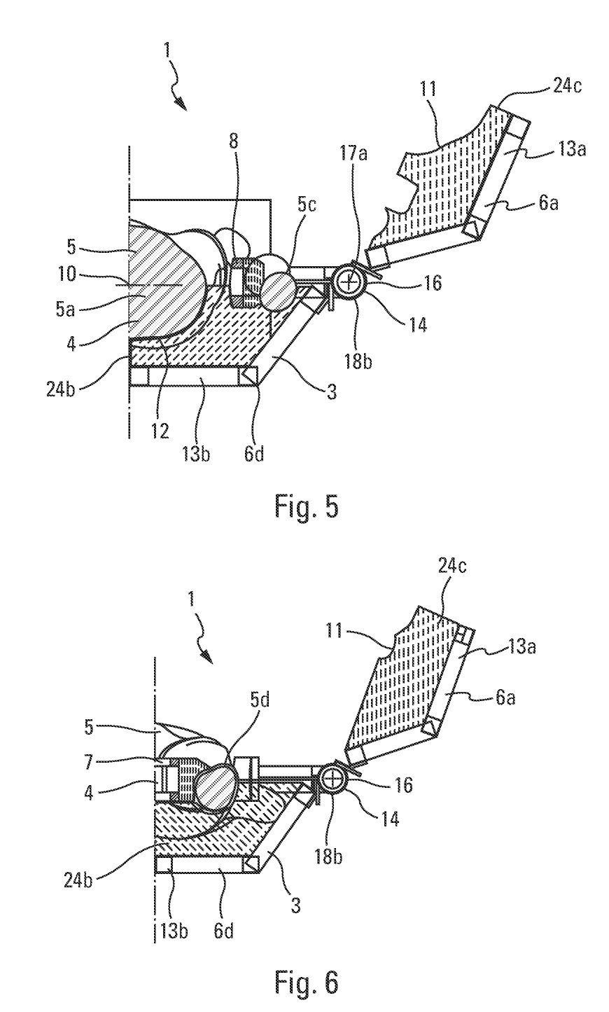

As can be seen in FIGS. 2 to 5 and 8 and 9 the movable structure comprises means for supporting the trunk 8. A portion of the means for supporting the trunk extends into a portion of the lying region 4 which is to the right of the trunk 5a and the other portion of the means for supporting the trunk 8 extends into a portion of the lying region 4 which is to the left of the trunk 5a. Each of these portions of the means for supporting the trunk is fixed to a right or left rail of the frame 16 according to whether it is intended to come on the right or on the left of the trunk of the patient. Each portion of the means for supporting the trunk forms an L of which the longest length is placed between an arm 5c and the trunk 5a and comprises a cushion on the arm side to come into contact against the arm and support it. The face of the support trunk which is oriented towards the trunk accepts and supports the section of mattress of the corresponding panel when the latter is in closed position.

The means for supporting the trunk 8 can be adjusted in length and in width in such a way as to be conformed to the morphology of the patient and to allow for a sufficient thickness of the cushion or of sections of mattress.

Each panel has its own elongated shape in a direction of elongation parallel to the main axis of elongation of the elongated lying region 10. In addition each panel is adapted to support a portion at least of the lying region when the lying region is positioned above this panel and is adapted to be separated from another of said panels in such a way as to allow access to said lying region 4 when said panels are in one of their opened-out configurations. As such the same panel is used as support for the lying region when it is under this lying region 4 and is used as a means of access to the lying region 4 when it is at least partially located above the lying region.

Preferentially, each panel, seen on its section perpendicular to the axis 9, when the panel is in closed position, comprises a side parallel to the plane of the frame 16, and another side oriented at 45° from this plane, in such a way as to allow for a rotation of the panel of 270° and its full retraction under the movable part in maximum opening. In maximum opening of the panels: when then movable part is horizontal, the plane at 45° of the non-supporting frame carries out a rotation of 270° and comes into junction with that of the supporting frame which is opposite; when the movable part is in lateral position, the planes at 45° of the non-supporting frames carry out a rotation of 135° and come opposite each other. In this same position, if a single panel is open it can carry out a rotation of 270° and come into junction with the other non-supporting panel which remained closed.

In order to maintain the panels in their closed position, as indicated previously, each panel carries means for locking 22 comprising two rods and a block for controlling in translation these rods in order to place each rod in one of its selective positions of locking or unlocking of the panel that carries it. Of course these means for locking 22 as well as said means of actuating panels 23 are connected to the electrical means of control 27 which is as such adapted to:
pivoting the movable structure;
locking or unlocking each panel;
controlling the passage of each panel in its opened-out or closed configuration.

1-15. (canceled)

16. Hospital bed comprising a fixed structure and a movable structure connected to said fixed structure in such a way as to allow the movable structure to pivot in relation to said fixed structure, said movable structure being supported by said fixed structure, the movable structure comprising an elongated patient lying region adapted to receive a patient in a stretched out position, and said movable structure further comprising at least three panels which can be moved selectively in relation to one another between a closed configuration wherein said elongated patient lying region of the movable structure is surrounded by said at least three panels and at least one opened-out configuration wherein at least two of said at least three panels are separated from one another in such a way as to allow access to said elongated patient lying region.

17. Bed according to claim 16, wherein said movable structure comprises leg support means of support for supporting the legs of the patient, said leg support means being arranged to maintain a separation between the legs of the patient stretched out in the elongated patient lying region and being adapted to prevent the weight of one of said legs of said patient from being transferred onto the other of said legs.

18. Bed according to claim 16, wherein said movable structure comprises trunk support means for supporting the trunk of the patient, said support means being arranged to independently support the trunk and the arms of the patient stretched out in the lying region and being adapted to prevent elongated patient the weight of the trunk of said patient from being transferred onto one of the arms of said patient which would be placed parallel to the trunk.

19. Bed according to claim 16, wherein the movable structure is adapted to pivot in relation to the fixed structure according to a pivoting axis extending parallel to a main axis of elongation of the elongated patient lying region.

20. Bed according to claim 16, wherein said movable structure comprises:
at least one front support surface adapted to accept as support at least one portion of the front face of said patient lying down in said elongated patient lying region; and
at least one rear support surface adapted to receive as support at least one portion of the rear face of said patient lying down in said elongated patient lying region, and
said at least one front and rear support surfaces being placed opposite one another at least when said panels are in the closed configuration.

21. Bed according to claim 16, wherein said bed has four of said panels which can be moved selectively in relation to one another between said closed configuration and said at least one opened-out configuration and in said closed configuration, said elongated patient lying region of the movable structure is surrounded by said four panels and in said at least one opened-out configuration, at least two said the four panels are separated from one another in such a way as to allow access to said elongated patient lying region to stretch out said patient therein.

22. Bed as claimed in claim 20, wherein two of said four panels form a first pair of panels and two other of said four panels form a second pair of panels said four panels being adapted to adopt:
a first opened-out configuration wherein the panels of said first pair of panels are separated from one another in such a way as to allow for an access to said elongated patient lying region by passing between the panels of said first pair of panels; and
a second opened-out configuration wherein the panels of said second pair of panels are separated from one another in such a way as to allow for an access to said elongated patient lying region by passing between the panels of said second pair of panels.

23. Bed as claimed in claim 22, wherein the panels are arranged in such a way that when they are in closed configuration:
the panels of said first pair of panels are then arranged opposite a front face of the patient lying down in said elongated patient lying region; and
the panels of said second pair of panels are then arranged opposite a rear face of said patient lying down.

24. Bed according to claim 16, wherein said movable structure comprises a chassis and in said liaison of the movable structure and of said fixed structure allowing said pivoting of the movable structure in relation to said fixed structure is carried out by mechanical connections between said fixed structure and said chassis.

25. Bed according to claim 24, wherein said bed comprises several sections of mattress and said elongated patient lying region is surrounded by said sections of mattress when said panels are in closed configuration, and each of said sections of mattress being assembled to at least one of said panels.

26. Bed according to claim 25, wherein said elongated patient lying region comprises a first portion of elongated patient lying region adapted to accept a first leg of the patient lying down in the elongated patient lying region and a second portion of elongated patient lying region adapted to accept a second leg of the patient lying down in said elongated patient lying region, said leg support means, being arranged between first and second portions of elongated patient lying region of legs of the patient lying down, said leg support means being assembled rigidly to said chassis of the movable structure in such a way as to prevent the weight of one leg of the patient from being transferred onto the other of said legs and in that said panels are mounted movable in relation to the chassis and in that at least one of said sections of mattress assembled to at least one of said panels being arranged in such a way that when said panels are in the closed configuration, said first portion of elongated patient lying region adapted to accept the first leg of the patient lying down in the elongated patient lying region is located between a portion at least of said leg support means and said at least one of said sections of mattress in such a way as to allow for a lateral bracing on either side of said first portion of elongated patient lying region.

27. Bed according to claim 26, wherein at least one other of said sections of mattress assembled to at least one other of said panels is arranged in such a way that when said panels are in closed configuration, said second portion of elongated patient lying region adapted to accept the second leg of the patient lying down in the elongated patient lying region is located between at least a portion of said leg support means and at least said at least one other section of mattress in such a way as to allow for a lateral bracing on either side of said second portion of elongated patient lying region.

28. Bed according to claim 24, wherein the chassis comprises an elongated peripheral frame supporting said panels and said frame is rotably mounted in relation to said fixed structure by first and second pivots respectively located on either side of said frame and on respective longitudinal ends of said frame.

29. Bed according to claim 28, wherein the frame comprises two rails and each of said panels is rotably mounted in relation to one or the other of the rails and of the frame.

30. Bed according to claim 16, wherein the bed comprises locking means for locking panels, which are selectively movable between:
a locking configuration preventing the panels from passing from the closed configuration to the opened-out configuration; and
an unlocking configuration that authorises the panels to pass from the closed configuration to the opened-out configuration.
